(19) United States
(12) Patent Application Publication
(10) Pub. No.: US 2022/0046206 A1
(43) Pub. Date: Feb. 10, 2022

(54) IMAGE CAPTION APPARATUS

(71) Applicant: Vingroup Joint Stock Company, Ha Noi City (VN)

(72) Inventors: Hung Hai BUI, Na Noi City (VN); Hoai Minh Nguyen, Na Noi City (VN); Thien Huu Nguyen, Ha Noi City (VN); Thu Minh Nguyen, Ha Noi City (VN)

(21) Appl. No.: 17/188,211

(22) Filed: Mar. 1, 2021

(30) Foreign Application Priority Data
Aug. 4, 2020 (VN) 1-2020-04487

(51) Int. Cl. H04N 7/08; G06T 9/00

(52) U.S. Cl. CPC H04N 7/08; G06T 9/00

(57) ABSTRACT

An image caption apparatus includes an encoder which encodes an input image; and a decoder which receives an output of the encoder. The decoder comprises a first long short-term memory (LSTM) configured to operate in cooperation with a second LSTM to respectively generate a first hidden vector and a second hidden vector, wherein the second hidden vector is used to generate a word for an output caption, a LSTM cell configured to be used for both the first LSTM and the second LSTM to generate the first hidden vector or the second hidden vector, wherein an personality embedding vector fed into the LSTM cell is employed to modulate an input signal of visual and language features of the internal gates of the LSTM cell, and a personality controller configured to decay the personality embedding vector at each word generation step before the personality embedding vector is fed into the LSTM cell.

### CROSS-REFERENCE TO RELATED APPLICATIONS

This application claims priority to Vietnamese Patent Application No. 1-2020-04487 filed on Aug. 4, 2020, which application is incorporated herein by reference in its entirety.

### BACKGROUND

### 1. Technical Field

Embodiments relate to an image caption apparatus.

### 2. Related Art

Image Captioning (IC) is an important and challenging problem in multi-modal artificial intelligence (AI) that aims to generate a natural language caption for a given image. The current state-of-the art approach for IC involves deep learning models where an encoder model is employed to obtain the feature maps to represent the input images. These feature maps are then fed into a decoder model that aims to sequentially generate the words for the output caption (i.e, the encoder-decoder architecture).

Most of the current work on IC has focused on a generic setting where the captions need to faithfully describe the visual concepts in the input images. Unfortunately, this generic setting does not capture other realistic scenarios where the caption generation process of a human tends to be influenced by his/her personality or trait. In such scenarios, depending on the personality trait, one might only express his or her opinion about some specific visual concepts, ignoring all other scenes in the images. This problem is called personalized image captioning (PIC) that, in addition to an input image, provides a personality trait for the models to be conditioned.

Among a few works on PIC, (Shuster et al., 2019) recently introduced a new dataset (i.e., PERSONALITY-CAPTIONS (PC)) of which a goal is to generate engaging captions for the input images by being conditioned on a personality trait. (Shuster et al., 2019) also presents a model for this problem leveraging the encoder-decoder architecture where the word embedding for the input trait is directly injected into the LSTM-based decoder at every word generation step. Although this model has achieved decent performance, there are at least two fundamental limitations that should be addressed to boost the performance. First, at each word generation step, the LSTM-based decoder model in (Shuster et al., 2019) directly uses the trait embedding vector as the input for the LSTM cells. As the LSTM cells of the decoder also take as input the representation vectors for the images and the previous hidden vectors for the previously generated words, the direct incorporation of the trait embeddings in the LSTM cell input essentially implies that the representation vectors for different modalities (i.e., images, trait, and languages) are fused by the simple concatenation vector. As demonstrated in the prior work (Perez et al., 2018), such a representation concatenation mechanism would produce suboptimal representation vectors for multi-model systems, thereby impairing the overall performance.

The second limitation of the decoder in (Shuster et al., 2019) is that it applies the same representation vector for the trait over different word generation steps. Ideally, the inventors expect that the trait representation vector should be customized for each word generation step, by being conditioned on the words that have been generated before. In particular, as the generated words might have expressed some level of information/semantics required by the original trait, the trait representation vectors for the current and future steps should be updated to reflect the remaining information of the trait, thus appropriately informing the model about the trait to generate the words in the next step.

### SUMMARY

Embodiments are directed to provide an image caption apparatus which allows different modalities (i.e., images, trait, and languages) in PIC to interact with each other more effectively in a long short-term memory (LSTM) cell of a decoder for PIC.

Embodiments are directed to providing an image caption apparatus which improves a representation vector for trait for text generation at each LSTM step.

The object of the embodiments is not limited to the above description and includes objects or effects that may be recognized from technical solutions or embodiments described hereinafter.

According to an aspect of the present invention, there is provided an image caption apparatus including an encoder which encodes an input image; and a decoder which receives an output of the encoder, wherein the decoder comprises a first long short-term memory (LSTM) configured to operate in cooperation with a second LSTM to respectively generate a first hidden vector and a second hidden vector, wherein the second hidden vector is used to generate a word for an output caption, a LSTM cell configured to be used for both the first LSTM and the second LSTM to generate the first hidden vector or the second hidden vector, wherein an personality embedding vector fed into the LSTM cell is employed to modulate an input signal of visual and language features of the internal gates of the LSTM cell, and a personality controller configured to decay the personality embedding vector at each word generation step before the personality embedding vector is fed into the LSTM cell.

The first LSTM corresponds with a visual attention model and the second LSTM corresponds with a language model.

The output of the encoder comprises a feature map representing the input image and an average feature vector representing the global information of the input image, the decoder is further configured to calculate a visual context vector based on the first hidden vector and the feature map, the first LSTM calculates the first hidden vector using a first input vector that is a combination of the average feature vector, a previous second hidden vector and a previously generated word, the second LSTM calculates the second hidden vector using a second input vector that is a combination of the first hidden vector and the visual context vector, and the input signal is formed based on the first input vector and a previous first hidden vector when the LSTM cell is used for the first LSTM and the input signal is formed based on the second input vector and the previous second hidden vector when the LSTM cell is used for the second LSTM.

A feature-wise transformation layer is coupled to each internal gate of the LSTM cell wherein the feature-wise transformation layer comprises a conditional layer normalization which receives the input signal and the personality embedding vector as an input.

The conditional layer normalization is computed based on scaling and shifting factors of modulating the input signal, a mean of the input signal and a standard deviation of the input signal, wherein the scaling and shifting factors are regulated by the personality embedding vector.

The personality controller comprises a controller vector to determine the amount of information from a previous personality embedding vector to be kept in the personality embedding vector.

The controller vector is calculated based on the previous first hidden vector and the previous second hidden vector.

### BRIEF DESCRIPTION OF THE DRAWINGS

FIG. 1 is a block diagram of an image caption apparatus according to an embodiment of the present invention.

FIG. 2 is a schematic diagram of the image caption apparatus according to the embodiment of the present invention.

FIG. 3 is a detailed diagram of a long short-term memory (LSTM) cell according to an embodiment of the present invention.

FIGS. 4 to 6 are diagrams illustrating simulation results according to an embodiment of the present invention.

### DETAILED DESCRIPTION

While the present invention is open to various modifications and alternative embodiments, specific embodiments thereof will be described and shown by way of example in the accompanying drawings. However, it should be understood that there is no intention to limit the present invention to the particular embodiments disclosed, and, on the contrary, the present invention is to cover all modifications, equivalents, and alternatives falling within the spirit and scope of the present invention.

It should be understood that, although the terms including ordinal numbers such as first, second, and the like may be used herein to describe various elements, the elements are not limited by the terms. The terms are used only for the purpose of distinguishing one element from another. For example, without departing from the scope of the present invention, a second element could be termed a first element, and similarly a first element could be also termed a second element. The term “and/or” includes any one or all combinations of a plurality of associated listed items.

In the case that one component is mentioned as being “connected” or “linked” to another component, it may be connected or linked to the corresponding component directly or other components may be present therebetween. On the other hand, in the case that one component is mentioned as being “directly connected” or “directly linked” to another component, it should be understood that other components are not present therebetween.

It is to be understood that terms used herein are for the purpose of the description of particular embodiments and not for limitation. A singular expression includes a plural expression unless the context clearly indicates otherwise. It will be further understood that the terms “comprises” and/or “comprising,” when used in this specification, specify the presence of stated features, integers, steps, operations, elements, components, and/or groups thereof but do not preclude the presence or addition of one or more other features, integers, steps, operations, elements, components, and/or groups thereof.

Unless defined otherwise, all the terms (including technical and scientific terms) used herein have the same meaning as commonly understood by one of ordinary skill in the art to which the present invention belongs. It will be further understood that the terms, such as those defined in commonly used dictionaries, should be interpreted as having meanings that are consistent with their meanings in the context of the relevant art and should not be interpreted in an idealized or overly formal sense unless expressly defined otherwise herein.

Hereinafter, embodiments will be described in detail with reference to the accompanying drawings, the same or corresponding elements will be given the same reference numbers regardless of drawing symbols, and redundant descriptions will be omitted.

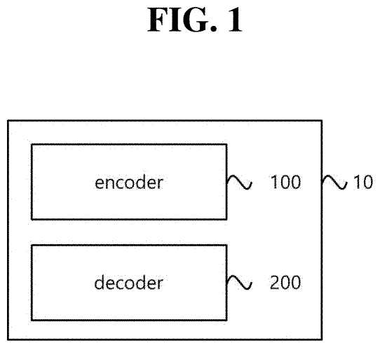

FIG. 1 is a block diagram of an image caption apparatus according to an embodiment of the present invention.

Referring to FIG. 1, an image caption apparatus 10 according to the embodiment of the present invention may include an encoder 100 and a decoder 200.

The encoder 100 may encode an input image into a smaller image. Such a process may be referred to as a process of summarizing useful information of an original image. Specifically, the encoder 100 may generate a feature map from the input image using a neural network algorithm pre-trained through a plurality of images. The encoder 100 may use a neural network algorithm such as a convolution neural network (CNN). As an example, the encoder 100 may use a ResNeXt ConvNet pre-trained through 3.5 billion Instagram images. In order to generate a feature map having a size of 7×7×512, the input image may be first input to a REsNeXt in which output is consumed by a 1×1 convolution. The feature map may include vectors of a plurality of dimensions into which visual content with respect to each cell of a preset image grid is encoded. For example, the feature map may be considered to include a set of 49 vectors of 512 dimensions. Each vector may encode visual content with respect to a cell of an image grid having a uniform size. The encoder 100 may generate an average feature vector from the input image. The average feature vector may represent global information about the input image.

The decoder 200 may generate a description sentence (i.e., an output caption) of the input image based on the output of the encoder. The decoder 200 may include a first long short-term memory (LSTM) operating in cooperation with a second LSTM to respectively generate a first hidden vector and a second hidden vector, wherein the second hidden vector is used to generate a word for an output caption. The decoder 200 may include a LSTM cell which uses for both the first LSTM and the second LSTM to generate the first hidden vector or the second hidden vector and a personality controller. A personality embedding vector fed into the LSTM cell may be employed to modulate an input signal of visual and language features of the internal gates of the LSTM cell. The personality controller may decay the personality embedding vector at each word generation step before the personality embedding vector is fed into the LSTM cell.

In the following exemplary embodiments, the term “Multi-gate Modulated LSTM Cell” or MATED-LSTM cell may be used synonymously with the LSTM cell according to the present invention.

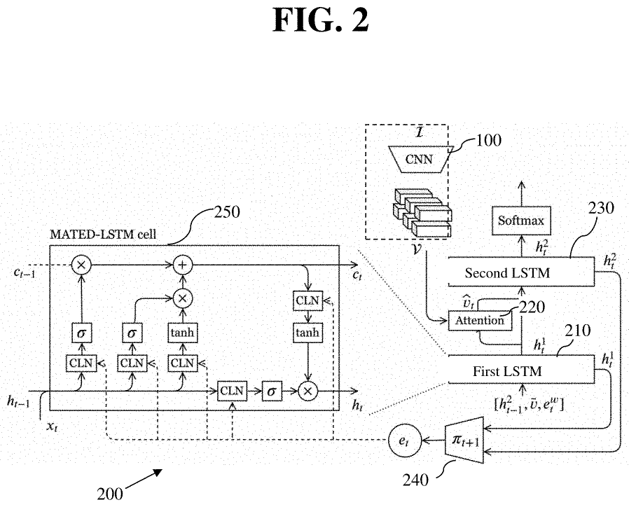

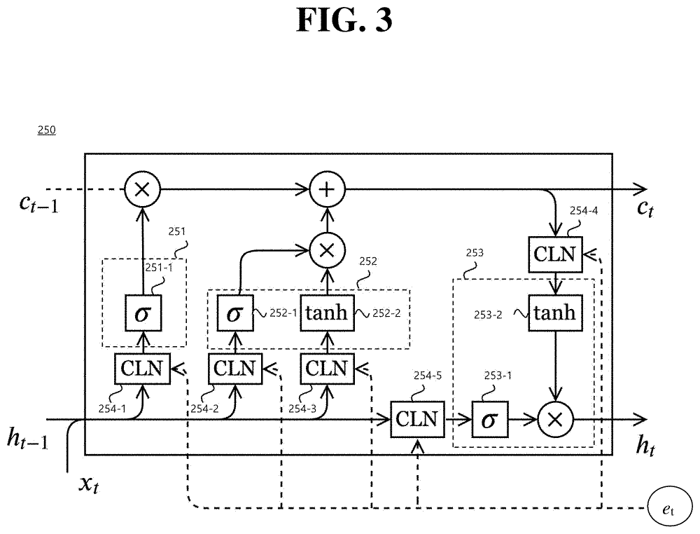

FIG. 2 is a schematic diagram of the image caption apparatus according to the embodiment of the present invention. FIG. 3 is a detailed diagram of the LSTM cell according to the embodiment of the present invention.

First, the encoder 100 may output a feature map V including a plurality of vectors and an average feature vector v̅ from an input image. The feature map V may be input to the attention mechanism 220. The attention mechanism 220 may be disposed between the first LSTM 210 and the second LSTM 230. The average feature vector v̅ may be used as an input of the first LSTM 210 of the decoder 200.

The decoder 200 may generates the output caption through a plurality of successive word generation steps in chronological order in which data from a current word generation step may be used as an input for a next word generation step or a current word generation step may use data from a previous word generation step. A time step in this specification means a word generation step. The previous components (e.g., first input vector, second hidden vector, etc.) in this specification mean the parameters of a word generation step being immediately before the current word generation step. The following embodiments describe the decoder operating in a word generation step.

The first LSTM and the second LSTM may operate cooperatively in which the data from the second LSTM may be used for the first LSTM and vice versa. The following embodiments describe this cooperation.

The first LSTM 210 may operate as a visual attention model. At the time step t, the first LSTM (i.e., attention LSTM) 210 may calculate a first hidden vector hₜ¹. The first LSTM 210 may have an input to generate the first hidden vector. The first LSTM 210 may calculate the first hidden vector through a first input vector xₜ¹ that is a combination of several components as in Equation 1 below:

xₜ¹=[hₜ₋₁²,v̅,wₜ₋₁] [Equation 1]

Here, xₜ¹ refers to the first input vector in the time step t, hₜ₋₁² refers to a second hidden vector calculated at time step t−1, v̅ refers to the average feature vector, and wₜ₋₁ refers to an embedding vector for a word generated in the time step t−1 by the second LSTM 230.

The attention mechanism 220 of the decoder 200 may calculate a visual context vector \hat{v}ₜ based on the first hidden vector and the feature map V. Specifically, the first hidden vector may be used as a query to calculate the normalized attention weight for each vector in the feature map V and may be used to generate the visual context vector as the weighted sum for the vector in the feature map V.

The second LSTM 230 may operate as a language model. The second LSTM (i.e., language LSTM) 230 may generate a second hidden vector hₜ². The second hidden vector may be input to a softmax in order to finally generate a word of an output caption. The second LSTM 230 may have an input to acquire the second hidden vector. The second LSTM 230 may calculate the second hidden vector through a second input vector xₜ² that is a combination of several components as in Equation 2 below:

xₜ²=[hₜ¹,\hat{v}ₜ]. [Equation 2]

Here, xₜ² may refer to the second input vector in the time step t, hₜ¹ may refer to the first hidden vector calculated in the time step t, and \hat{v}ₜ may refer to the visual context vector in the time step t.

The LSTM cell 250 may be used for both the first LSTM 210 and the second LSTM 230 to generate the first hidden vector hₜ¹ or the second hidden vector hₜ².

The LSTM cell 250 may include a plurality of internal gates and a plurality of feature-wise transformation layers.

The plurality of internal gates may include an input gate 252, a forget gate 251, and an output gate 253. The forget gate 251 may be a gate that determines which information is to be discarded and may use a sigmoid layer. The forget gate 251 may generate an output value based on an previous hidden vector hₜ₋₁ and a current input vector xₜ. The forget gate 251 may generate the output value by inputting the previous hidden vector hₜ₋₁ and the current input vector xₜ to a first sigmoid layer 251-1 and processing the previous hidden vector hₜ₋₁ and the current input vector xₜ. The LSTM cell 250 processes data cₜ₋₁ input in the previous time step based on data output by the forget gate 251. For example, when the output value is 1, the data cₜ₋₁ may be maintained, and when the output value is 0, the data cₜ₋₁ may be deleted.

The input gate 252 may be a gate that determines which information of new information is to be stored and may use a second sigmoid layer 252-1 and a first tan h layer 252-2. The first tan h layer 252-2 may generate vectors representing new protection values. Data for updating a state is generated based on data output from the input gate 252 and the first tan h layer 252-2. For example, the LSTM cell 250 may update an output cₜ₋₁ of the previous time step processed by the forget gate 251 to generate an output cₜ of a current time step. The output cₜ of the current time step may be transferred to a next time step.

The output gate 253 may output a filtered value based on a cell state. The output gate 253 may process the input vector xₜ using a third sigmoid layer 253-1. The output gate 253 may determine which portion of the cell state is to be output. The output gate 253 may output only a specific portion of the cell state by multiplying a predetermined value calculated by inputting cell state information cₜ to a second tan h layer 253-2 by an output value of the third sigmoid layer 253-1.

A personality embedding vector representing trait/personality information may be injected into the LSTM cell.

The LSTM may further include a plurality of feature-wise transformation layers coupled to the plurality of internal gates where the personality embedding vector is employed to modulate an input signal of visual and language features of the internal gates of the LSTM cell so that only the relevant information for the personality information is retained in the internal gates of the LSTM cell.

A plurality of feature-wise transformation layers 254-1 to 254-5 may be coupled to layers included in the plurality of internal gates. For example, a first feature-wise transformation layer 254-1 may be disposed in front of the first sigmoid layer 251-1 included in the forget gate 251. A second feature-wise transformation layer 254-2 may be disposed in front of the second sigmoid layer 252-1 included in the input gate 252. A third feature-wise transformation layer 254-3 may be disposed in front of the first tan h layer 252-2 included in the input gate 252. A fourth feature-wise transformation layer 254-4 may be disposed in front of the second tan h layer 253-2 included in the output gate 253. A fifth feature-wise transformation layer 254-5 may be disposed in front of the third sigmoid layer 253-1 included in the output gate 253.

Each of the plurality of feature-wise transformation layers may include a conditional layer normalization which receives the input signal and the personality embedding vector as an input.

The conditional layer normalization may be computed based on scaling and shifting factors of modulating the input signal, a mean of the input signal and a standard deviation of the input signal, where the scaling and shifting factors are regulated by the personality embedding vector. Specifically, for each gate g of the LSTM cell, a conditional layer normalization CLN_{g}(x,e) may be computed based on Equation 3 below:

$${CLN}_{g} ( x , e ) = \frac{x - μ}{σ} ⊙ γ + β . \qquad [ Equation 3 ]$$

Here, x refers to the input signal, and e refers to the personality embedding vector. μ refers to the mean of the input signal, and σ refers to the standard deviation of the feature values of the input signal. γ refers to the scaling factor, and β refers to the shifting factor. ⊙ refers to element-wise multiplication.

The scaling factor may be represented by Equation 4 below:

γ=W_{g}^{γ}e. [Equation 4]

Here, γ refers to the scaling factor, and W_{g}^{γ} refers to a first learning parameter.

The shifting factor may be represented by Equation 5 below:

β=W_{g}^{β}e. [Equation 5]

Here, β refers to the shifting factor, and W_{g}^{β} refers to a second learning parameter.

In order to stabilize all features of the input signal x before applying transformation, first, the mean μ of the input signal is subtracted from the input signal, the result is then divided by a standard deviation thereof σ to normalize the features of an input signal x with respect to each gate. The model according to this embodiment of the present invention is similar to a layer normalization module as reported in Layer normalization, 2016 of Jimmy Lei Ba, Jamie Ryan Kiros, and Geoffrey E. Hinton (incorporated herein by reference) in which scaling and shifting vectors are not adjusted by a personality embedding vector.

An output of each of internal gates included in the LSTM cell and the final output of the LSTM cell at the time step t may be represented by Equation 6 below:

iₜ=σ(CLNᵢ(Wᵢ[hₜ₋₁,xₜ],e))

fₜ=σ(CLN_{f}(W_{f}[hₜ₋₁,xₜ],e))

oₜ=σ(CLNₒ(Wₒ[hₜ₋₁,xₜ],e))

\tilde{c}ₜ=tan h(CLN_{\tilde{c}}(W_{\tilde{c}}[hₜ₋₁,xₜ],e))

cₜ=fₜ⊙cₜ₋₁+iₜ⊙cₜ

hₜ=oₜ⊙ tan h(CLN_{c}(cₜ,e)). [Equation 6]

Here, iₜ may refer to an input gate's activation vector in the time step t, fₜ may refer to a forget gate's activation vector in the time step t, oₜ may refer to an output gate's activation vector in the time step t, \tilde{c}ₜ may refer to a cell input activation vector in the time step t, cₜ may refer to a cell state vector in the time step t, and hₜ may refer to a hidden vector in the time step t. The input signal of each internal gate at time step t is formed based on an input vector xₜ and a previous hidden vector hₜ₋₁ as indicated in combination of Equations 3 and 6.

The LSTM cell may be used for both the first LSTM and the second LSTM with xₜ defined in Equations 1 and 2. That is, when the LSTM cell is used for the first LSTM, the input signal is formed based on the first input vector and a previous first hidden vector to generate the first hidden vector. When the LSTM cell is used for the second LSTM, the input signal is formed based on the second input vector and a previous second hidden vector to generate the second hidden vector.

The personality controller 240 may decay the personality embedding vector at each word generation step before the personality embedding vector is fed into the LSTM cell.

In a start time step in which a word is not generated, a personality embedding vector e₁ may be set as a preset original personality embedding vector e (that is, e₁=e). Thereafter, in order to generate a personality embedding vector with respect to the time step t, the personality controller 240 may comprise a controller vector for determining how much information should be maintained in a current vector eₜ from a previous personality embedding vector eₜ₋₁. Since a controller vector is adjusted according to a hidden vector in a previous time step of the first LSTM 210 and the second LSTM 230, the personality embedding vector may be customized based on a previously generated word.

The controller vector is calculated using Equation 7 below:

πₜ=σ(W_{π}[hₜ₋₁¹,hₜ₋₁²]). [Equation 7]

Here, πₜ refers to a controller vector in a time step t, hₜ₋₁¹ refers to a first hidden vector in the time step t−1, and hₜ₋₁² refers to a second hidden vector in the time step t−1.

The personality embedding vector may be calculated using Equation 8 below:

eₜ=πₜ⊙eₜ₋₁. [Equation 8]

Here, eₜ refers to a personality embedding vector in the time step t, πₜ refers to a controller vector in the time step t, and eₜ₋₁ refers to a personality embedding vector in the time step t−1.

When a personality embedding vector is equally used in all steps, a word generated in a previous time step may not be considered. As a result, efficiency can be increased in consideration of a word that may represent a partial aspect of personality. According to the present invention, a personality representation vector may be adaptively decayed at each time step before being supplied to the LSTM cell 250, thereby overcoming such an issue. The personality embedding vector eₜ may become an adaptive personality embedding vector with respect to the time step t of a word generation step in the decoder 200.

In order to generate the next word for outputting a caption, a second hidden vector hₜ² in the time step t is fed to a feed-forward network that calculates a coarse probability distribution in a pre-stored world vocabulary. A negative log-likelihood function below may be used as a loss function in corresponding work.

L=−Σₜ₌₁^{l} log P(yₜ|hₜ²) [Equation 9]

Here, L refers to a loss function, l refers to a length of a caption, and yₜ refers to a t^{th} word of a training caption.

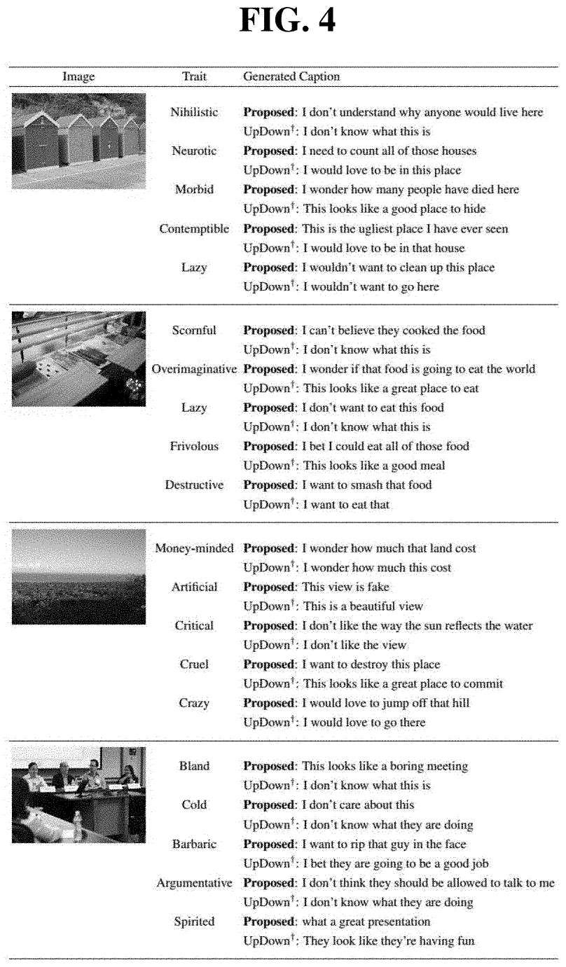

Hereinafter, simulation results according to an embodiment of the present invention will be described with reference to FIGS. 4 to 6.

FIGS. 4 to 6 are diagrams illustrating the simulation results according to the embodiment of the present invention. FIGS. 4 to 6 show simulation results of the image caption apparatus according to the embodiment of the present invention and a conventional image caption apparatus.

Experiments

Dataset and Hyper-parameters: The model in this invention were evaluated using the PERSONALITYCAPTIONS (PC) dataset introduced in Engaging image captioning via personality, 2019 of Kurt Shuster, Samuel Humeau, Hexiang Hu, Antoine Bordes, and Jason Weston (Incorporated herein by reference). This dataset involves 241,858 triplets of image-caption-personality for 215 personality types. The dataset was divided into three parts with 186K+ examples for training data, 5K examples for the development data (with only one caption reference per input image), and 10K examples for the test data (with 5 caption references per input image). The hyper-parameters are fine-tuned for the proposed model using the development dataset.

Model Parameters

The hyper-parameters for the proposed model in this invention were fine-tuned using the development dataset of PERSONALITY-CAPTIONS. The selected hyper-parameters include: 0:001 for the learning rate of the Adam optimizer that is decayed by the number of epoch to 3.5×10⁻⁵, the range [−2; 2] for gradient clipping, 512 for the dimension of the hidden vectors in the LSTM models, 256 for the batch size in mini-batching, and 3 for the beam search size in the inference time. The model were trained with 50 epochs using early stopping on the development data. For the trade-off parameter in the loss function, in each epoch, it was set to the ratio between the current number of epochs and the total number of epochs. Finally, the initial personality embeddings were obtained from the Glove pre-trained word embeddings as reported in Glove: Global vectors for word representation, in EMNLP, 2014 of Jeffrey Pennington, Richard S ocher, and Christopher Manning (incorporated herein by reference).

Comparing to the State-of the-Art

The proposed model in this invention was compared with the state-of-the-art models on the test data. In particular, the proposed model was compared with the following baseline models:

(1) ShowTell: the encoder-decoder architecture with a single language LSTM model for the decoder (Vinyals et al., 2014). The input for the LSTM in this model involves the concatenation of three vectors: the average visual feature vector the static personality embedding, and the word embeddings of the previous work,

(2) ShowAttTell (Xu et al., 2015): this model is similar to ShowTell except that the average vector is replaced by the weighted sum of the visual features in V, and

(3) UpDown: this is the encoder-decoder model with two layers of LSTM for the decoder used in (Shuster et al., 2019) as described in the invention. UpDown follows the architecture proposed in (Anderson et al., 2017), and it is the current state-of-the-art model on the PC dataset.

(4) UpDown⁺ is our reimplementation of UpDown, with a minor improvement by using the PTBTokenizer in the Stanford CoreNLP tookit. The proposed model is built upon UpDown+. The inventors used several typical performance measures, including BLEU, ROUGE-L, CIDEr, and SPICE. Table 1 presents the performance of the models. The proposed method outperforms the state-of-the-art methods on four out of five metrics.

Ablation Study

There are two novel components introduced into the encoder-decoder model for PIC in this invention, i.e., the feature-wise personality-based modulation of the visual and language representations/features in the LSTM gates (i.e., the MATED-LSTM cell), and the controller vector πₜ for personality trait decaying (i.e., the personality controller). In order to demonstrate the effectiveness of these components, the inventors perform an ablation study where the two components are incrementally removed from the full model. Table 2 shows the results.

TABLE 1

| Models | B@1 | B@4 | R | C | S |
|---|---|---|---|---|---|
| ShowTell | 38.4 | 7.3 | 24.3 | 9.6 | 1.6 |
| ShowAttTell | 43.3 | 7.1 | 27.0 | 12.6 | 3.6 |
| UpDown | 44.4 | 8.0 | 27..4 | 16.5 | 5.2 |
| UpDown^{†} | 49.5 | 9.9 | 29.7 | 16.1 | 4.3 |
| The proposed model^{†} | 50.7 | 10.9 | 30.5 | 17.3 | 4.7 |

TABLE 2

| Components | Combinations | | | |
|---|---|---|---|---|
| MATED-LSTM | ✓ | ✓ | X | X |
| Trait controller | ✓ | X | ✓ | X |
| BLEU@1 | 50.7 | 50.6 | 50.7 | 49.5 |
| BLEU@4 | 10.9 | 10.6 | 9.1 | 9.9 |
| ROUGE-L | 30.5 | 30.5 | 29.8 | 29.7 |
| CIDEr | 17.3 | 16.7 | 15.6 | 16.1 |
| SPICE | 4.7 | 4.4 | 4.1 | 4.3 |

As can be seen from the Tables, both components MATED-LSTM and personality controller are important for the proposed model as excluding any of them would hurt the performance measures. The MATED-LSTM seems to contribute more to the overall model as its absence would lead to a deeper performance drop than those with the trail controller. Interestingly, when both components are removed, some performance measures (i.e., BLUE@4 and CIDEr) are even better compared to the case when only MATED-LSTM is excluded (i.e., only the personality controller is used). This suggests the importance of MATED-LSTM to enable the personality controller to work for PIC.

While the experimental results demonstrate the benefit of the proposed model quantitatively, some additional analysis was performed to gain a better insight into the operation of the models.

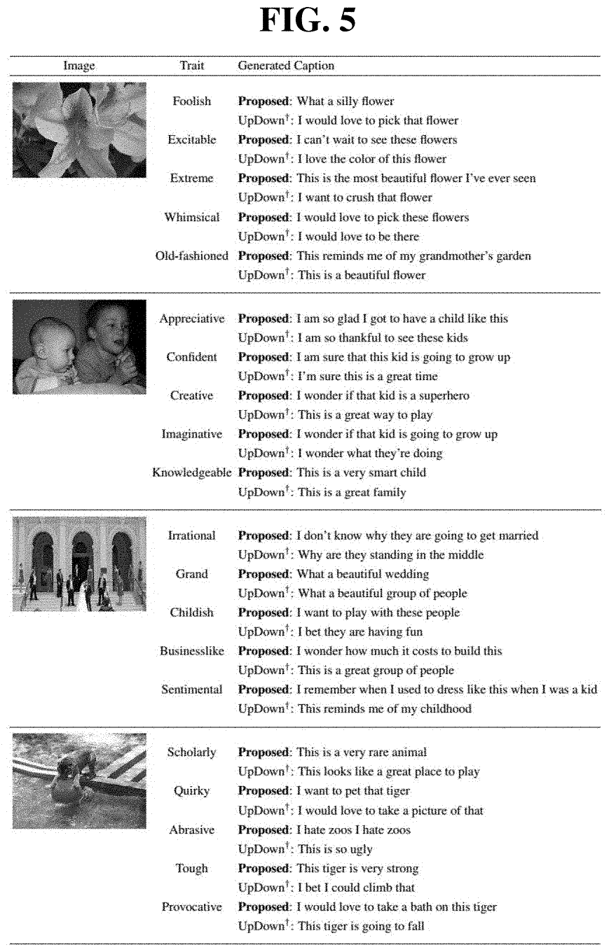

In particular, the outputs of the proposed model and UpDown⁺ were analyzed on two scenarios with seen and unseen personality traits. In the first scenario, given an image from the development data, both models were used to generate captions for every personality trait in the dataset (i.e., the 215 known personality traits). By comparing a sample of outputs of the two models over different input images and personality traits, it is found that UpDown⁺'s generated captions tend to be less engaging and less consistent with the personality traits that those from the proposed model. FIG. 4 and FIG. 5 presents some examples for the two models on the seen personality traits.

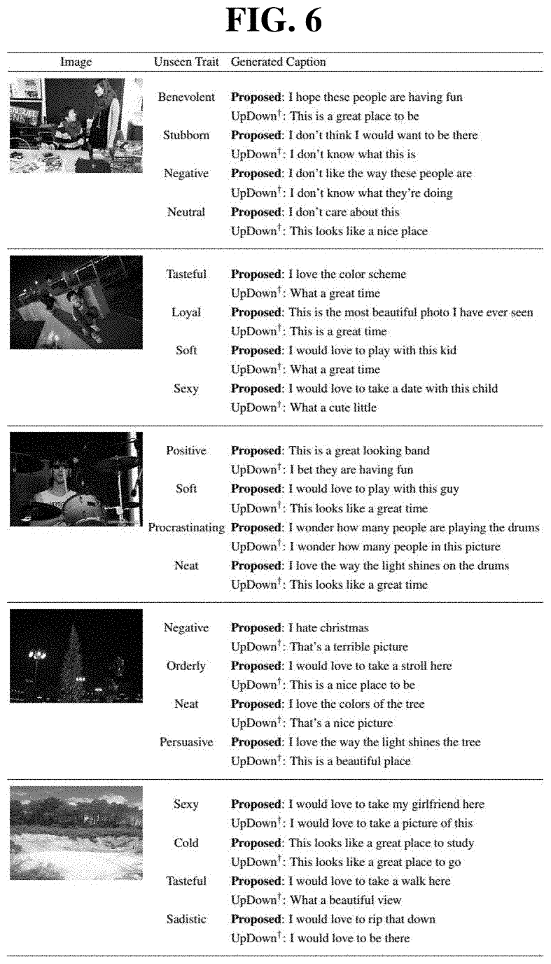

In the second scenario, the experiment seeks to evaluate the generalization of the models over unseen personality traits. In particular, firstly 30 new personality traits (those not used in the PERSONALITY-CAPTIONS dataset) were selected from the ideonomy dictionary (e.g., sexy, stubborn) (http://ideonomy.mit.edu/essays/traits.html). Note that the 215 personality traits in the PERSONALITY-CAPTIONS dataset were also obtained from this dictionary. Afterward, both the proposed model and the UpDown⁺ model were used to generate captions for the images in the development data using the new personality traits. Based on our analysis of a sample of the outputs in this experiment, it is observed that UpDown⁺ tends to produce the phrases with high frequency in the training data for the new personality traits (e.g., “having a good time” even for such general traits as neural and negative). This is in contrast to the proposed model that can generate more reasonable and engaging captions on the new personality traits, suggesting the better generalization of the proposed model in these scenarios. FIG. 6 presents some examples for UpDown⁺ and the proposed model on the unseen personality traits. The proposed model attributes the better quality and generalization of the captions by the employment of the feature-wise personality-based modulation in the LSTM gates to enable better interaction between the modalities, and the decaying personality mechanism to adaptively distribute the personality information over the word generation steps for the model.

According to an embodiment, it is possible to provide a high accuracy image caption.

The various and advantageous advantages and effects of the present invention are not limited to the above description and may be more easily understood in the course of describing specific embodiments of the present invention.

While the present invention has been mainly described with reference to the embodiments, it should be understood that the present invention is not limited to the disclosed embodiments and that various modifications and applications may be devised by those skilled in the art without departing from the gist of the present invention. For example, each component specifically shown in the embodiment may be modified and implemented. Differences related to these modifications and applications should be construed as being within the scope of the present invention defined by the appended claims.

What is claimed is:

1. An image caption apparatus comprising:
an encoder which encodes an input image; and
a decoder which receives an output of the encoder, wherein the decoder comprises:
a first long short-term memory (LSTM) configured to operate in cooperation with a second LSTM to respectively generate a first hidden vector and a second hidden vector, wherein the second hidden vector is used to generate a word for an output caption;
a LSTM cell configured to be used for both the first LSTM and the second LSTM to generate the first hidden vector or the second hidden vector, wherein an personality embedding vector fed into the LSTM cell is employed to modulate an input signal of visual and language features of the internal gates of the LSTM cell; and
a personality controller configured to decay the personality embedding vector at each word generation step before the personality embedding vector is fed into the LSTM cell.

2. The image caption apparatus of claim 1, wherein the first LSTM corresponds with a visual attention model and the second LSTM corresponds with a language model.

3. The image caption apparatus of claim 1, wherein
the output of the encoder comprises a feature map representing the input image and an average feature vector representing the global information of the input image,
the decoder is further configured to calculate a visual context vector based on the first hidden vector and the feature map,
the first LSTM calculates the first hidden vector using a first input vector that is a combination of the average feature vector, a previous second hidden vector and a previously generated word,
the second LSTM calculates the second hidden vector using a second input vector that is a combination of the first hidden vector and the visual context vector, and
the input signal is formed based on the first input vector and a previous first hidden vector when the LSTM cell is used for the first LSTM and the input signal is formed based on the second input vector and the previous second hidden vector when the LSTM cell is used for the second LSTM.

4. The image caption apparatus of claim 1, wherein a feature-wise transformation layer is coupled to each internal gate of the LSTM cell wherein the feature-wise transformation layer comprises a conditional layer normalization which receives the input signal and the personality embedding vector as an input.

5. The image caption apparatus of claim 4, wherein the conditional layer normalization is computed based on scaling and shifting factors of modulating the input signal, a mean of the input signal and a standard deviation of the input signal, wherein the scaling and shifting factors are regulated by the personality embedding vector.

6. The image caption apparatus of claim 1, wherein the personality controller comprises a controller vector to determine the amount of information from a previous personality embedding vector to be kept in the personality embedding vector.

7. The image caption apparatus of claim 6, wherein the controller vector is calculated based on the previous first hidden vector and the previous second hidden vector.
